(19) United States
(12) Patent Application Publication
(10) Pub. No.: US 2013/0268171 A1
(43) Pub. Date: Oct. 10, 2013

(54) SUPPLEMENTAL ELECTRIC PARK BRAKE SYSTEM

(71) Applicants: Tim Allen Huls, Plymouth, MI (US); Mark Edward Zyskowski, Dearborn, MI (US); William Russel Goodwin, Farmington Hills, MI (US); Rich Reynolds Hathaway, Livonia, MI (US); Jeffrey James Tumavitch, Livonia, MI (US); Brian J. Deurloo, Howell, MI (US); Todd Curtis Spaulding, Ann Arbor, MI (US)

(72) Inventors: Tim Allen Huls, Plymouth, MI (US); Mark Edward Zyskowski, Dearborn, MI (US); William Russel Goodwin, Farmington Hills, MI (US); Rich Reynolds Hathaway, Livonia, MI (US); Jeffrey James Tumavitch, Livonia, MI (US); Brian J. Deurloo, Howell, MI (US); Todd Curtis Spaulding, Ann Arbor, MI (US)

(73) Assignee: Ford Global Technologies LLC

(21) Appl. No.: 13/438,930

(22) Filed: Apr. 4, 2012

(51) Int. Cl. B60W 10/196; B60W 10/10

(52) U.S. Cl. 701/70

(57) ABSTRACT

The present disclosure relates to a method for controlling an electric park brake, including: receiving shift-command data related to operator shift commands; receiving transmission-operating-gear data related to a transmission mode of operation; comparing shift-command data and transmission-operating-gear data; and actuating an electric park brake when shift-command data fails to match transmission-operating-gear data.

### TECHNICAL FIELD

The present disclosure relates to control systems and logic for electric park brakes.

### BACKGROUND

Parking vehicles for an extended period of time can be accomplished through various kinds of braking systems including, for example, holding the service brakes, shifting the vehicle transmission into park, or actuating a parking brake. Today, park brakes can be electrically actuated and controlled. With electric park brakes, greater control is provided. Actuation of the park brake can be performed automatically, i.e., independent of operator input.

One patent discusses activating a power parking brake if an automated parking position in a vehicle transmission is unable to function and vice versa—U.S. Pat. No. 6,256,568 titled “Motor Vehicle Having an Electronically Controlled Automatic Transmission and a Power Parking Brake.” There still is a need for detailed transmission component failures to be detected by a control module and relayed to an electric park brake controller to actuate supplemental braking.

Therefore, it is desirable to have a robust method of detecting different failure modes in a transmission park brake and actuating an electric park brake to supplement the transmission park brake when needed. It is also desirable to have a warning or indication when the electric park brake does not engage.

### SUMMARY

The present disclosure addresses one or more of the above-mentioned issues. Other features and/or advantages will become apparent from the description which follows.

One exemplary embodiment relates to a method for controlling an electric park brake, comprising: receiving shift-command data related to operator shift commands; receiving transmission-operating-gear data related to a transmission mode of operation; comparing shift-command data and transmission-operating-gear data; and actuating an electric park brake when shift-command data fails to match transmission-operating-gear data.

Another exemplary embodiment relates to a control module for supplemental park brake control, having: shift assessment logic configured to receive shift-command data and transmission-operating-gear data; shift comparison logic configured to compare shift-command data to transmission-operating-gear data; and EPB control logic configured to actuate an electric park brake when shift-command data fails to match transmission-operating-gear data.

Another exemplary embodiment relates to a vehicle with supplemental park brake system, including: a shift lever; a shift position sensor configured to detect shift lever position and electrically send signals related to shift lever position to a PCU; and a transmission range sensor configured to send signals related to transmission operating gear to the PCU. The PCU is configured to communicate with a BCM configured to actuate an electric park brake when shift position data does not match transmission gear data.

Another exemplary embodiment relates to a vehicle with supplemental park brake system, including: a PCU; and a transmission shifter configured to send shift-command data to a PCU. The PCU is configured to receive transmission-operating-gear data. The PCU is configured to communicate with a BCM configured to actuate an electric park brake when shift-command data does not match transmission-operating-gear data.

One advantage of the present disclosure is that the supplemental electric park brake enables actuation of the park brake automatically, i.e., independent of operator input when a failure mode is detected, unlike mechanical park brakes.

The invention will be explained in greater detail below by way of example with reference to the figures, in which the same reference numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 is a schematic depiction of a supplemental electric park brake system for a vehicle according to an exemplary embodiment of the present invention.

FIG. 2 is a schematic depiction of a supplemental electric park brake system for a vehicle according to another exemplary embodiment.

FIG. 3 is a schematic depiction of a control circuit for a supplemental electric park brake system.

### DETAILED DESCRIPTION

Referring to the drawings, wherein like characters represent examples of the same or corresponding parts throughout the several views, there are shown exemplary supplemental electric park brake systems and control circuits. The parking brake systems are configured to send an “apply” command to electric park brakes to supplement another vehicle park brake system. Particularly, in the illustrated embodiments, a brake control module (or BCM) is in communication with a powertrain control module (or PCM) so that the electric park brake can be used to supplement transmission parking. In this manner, the supplemental electric park brake enables actuation of the park brake automatically, i.e., independent of operator input when a failure mode is detected. The electric park brake is used to maintain a static condition of the vehicle.

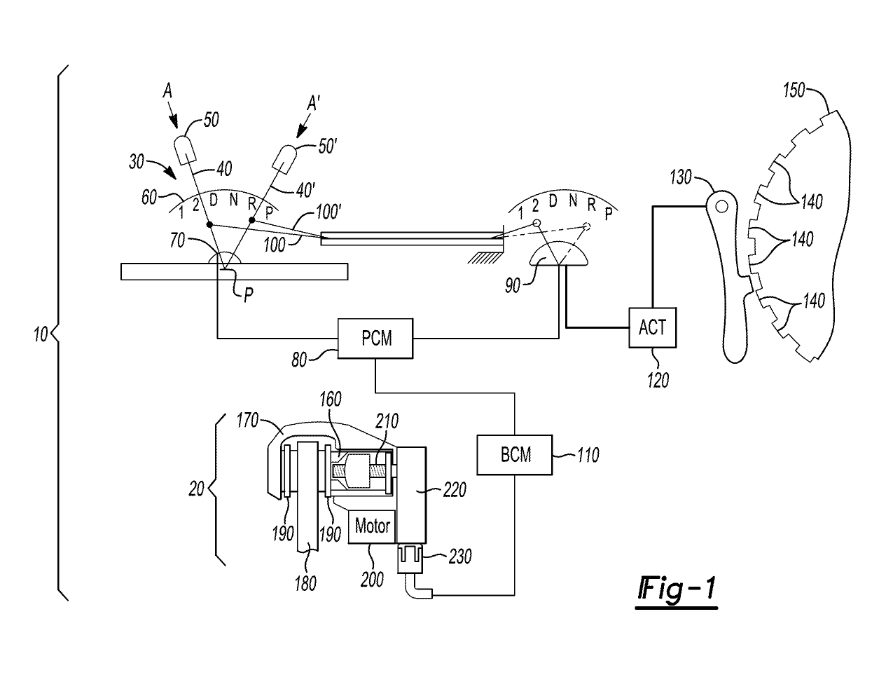

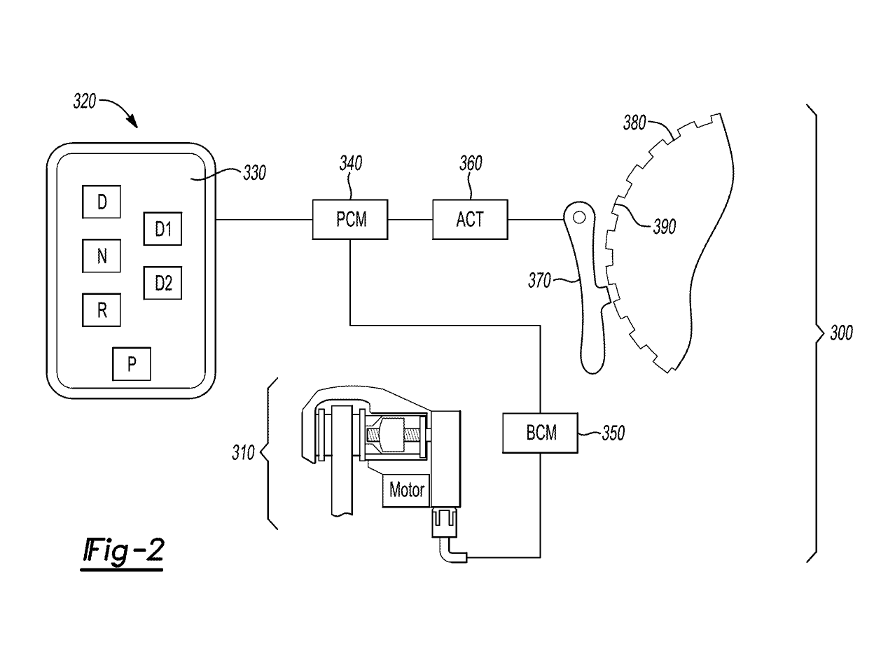

The illustrated systems are capable of executing a method for controlling an electric park brake. Exemplary conditions for EPB actuation are listed and discussed hereinbelow with respect to Tables 1 and 2. The method includes the steps of: (i) receiving shift-command data related to operator shift commands; (ii) receiving transmission-operating-gear data related to a transmission mode of operation; (iii) comparing shift-command data and transmission-operating-gear data; and (iv) actuating an electric park brake when shift-command data fails to match transmission-operating-gear data. Shift-command data includes any shift request from the driver to the vehicle. Shift-command data also can include perception of driver requests for transmission mode of operation as expressed, for example, through a transmission shifter such as the shift lever (e.g., 40 as shown in FIG. 1), a keypad (e.g., 320 as shown in FIG. 2) or voice recognition software.

Transmission-operating gear data relates to the transmission mode of operation. Transmission-operating gear data pertains to information received from the transmission range sensor about the gear that the transmission is operating in—e.g., drive, 1^{st}, neutral, 2^{nd}, reverse and park.

The method can be executed in part or in total by the PCM, BCM or a VCM. Control modules include a microcontroller. Microcontroller can be incorporated in other vehicle control modules including but not limited to the engine control unit, transmission control unit, battery control module or vehicle control module. Microprocessor can be any sort of computer or control circuit such as a computer having a central processing unit, memory (e.g., RAM and/or ROM), and associated input and output buses. The microprocessor can be application-specific integrated circuits or can be formed of other logic devices.

In an alternative embodiment, the method for controlling an electric park brake further includes: receiving park-pawl data related to park pawl position; comparing park-pawl data to shift-command data and transmission-operating-gear data; and actuating the electric park brake when park-pawl data does not match shift-command data or transmission-operating-gear data. This logic is also shown in the decision tables Table 1 and Table 2 as discussed above.

In another embodiment, the method for controlling an electric park brake further includes: checking the electric park brake when the shift-command data fails to match transmission-operating-gear data to determine if the electric park brake engaged after actuation; and sending a warning signal if the electric park brake fails to engage. Warning signal can be sent to the VCM (or vehicle control module) and trigger a user display on the instrument panel.

Referring now to FIG. 1, there is shown therein a supplemental electric park brake system 10. An electric park brake (or EPB) 20 locks the vehicle wheels to supplement transmission braking. As illustrated, the system 10 includes a transmission shifter 30. A shift lever 40 is incorporated in the vehicle cabin so that a vehicle operator can shift the vehicle into park. Shift lever 40 is configured to pivot about point P. A shift knob 50 acts as a handle at the top of the shift lever 40. A shift gate 60 is schematically shown. In this embodiment, the available shift options are 1^{st}, 2^{nd}, drive, neutral, reverse and park. Shift lever 40 is shown in two positions in FIG. 1. In position A the shift lever is in the drive gear. In position A′ the shift lever is in park. (40′, 50′ and 100′ correlate to the shift lever, shift knob and shift cable when in position A′). The shifter 30 includes a position sensor 70 at the pivot point, P, of the shift lever. Shift position sensor 70 can be, for example, a potentiometer. Shift position sensor 70 is linked to a PCM 80. PCM 80 is a control module configured to control a transmission mode of operation and receive data related to transmission operation.

Shift lever 40, as shown in FIG. 1, is mechanically liked to a transmission range sensor (or TRS) 90. TRS 90 determines shift lever position according to the force applied to a shift cable 100. TRS 90 communicates shift commands to the PCM 80. PCM 80 controls transmission gear operation according to data from the TRS 90. Where data related to shift command, as received from the shift position sensor 70, does not match data related to transmission gear of operation, as received from the TRS 90, BCM 110 sends an actuation command to the EPB 20. Particularly, when the shift lever 40 is shifted into the park position (A as shown in FIG. 1) and the TRS 90 does not detect that the transmission is in park the PCM 80 sends this information to BCM 110 and BCM send an actuation command to the EPB 20.

In this embodiment, TRS 90 is linked to an actuator 120 for a park pawl 130. Actuator 120 is motor powered configured to pivot park pawl 130 with respect to teeth 140 in the transmission housing 150. When the transmission is operating in park, pawl 130 pivots into engagement with the toothed surface on the transmission housing 150 to lock the pawl with respect to the transmission housing 150.

Exemplary conditions for BCM 110 transmittal of an actuation signal to the EPB 20 using the system illustrated in FIG. 1 are shown in Table 1.

TABLE 1
EPB Actuation to Supplement Transmission Braking

| Condition | Action |
|---|---|
| Shift position ≠ TRS value | PCM sends actuation |
| | command to EPB |
| Pawl position ≠ TRS value | PCM sends actuation |
| | command to EPB |
| Pawl position ≠ shift position | PCM sends actuation |
| | command to EPB |
| TRS receives current spike | PCM sends actuation |
| from pawl actuator | command to EPB |
| EPB not actuated | Warning signal to VCM |

Several conditions trigger BCM 110 signal for EPB actuation. For example, where TRS 90 detects an abnormal current request from the actuator motor, TRS sends a signal to the PCM 80. PCM 80 then sends a signal to the BCM 110. Likewise, where the park pawl position data does not match shift command data, PCM 80 sends an actuation signal to the BCM 110 to actuate the EPB 20.

Once an actuation signal is received, the BCM 110 instructs the EPB 20 to actuate and lock the wheels. The EPB 20, as shown in FIG. 1, pertains to motor-actuation of a piston 160 and caliper 170 for disc brakes. Brakes include a brake rotor 180. Brake pads 190 are attached to each side of the brake rotor so that the rotor 180 can freely move when the caliper 170 is not actuated. In the illustrated version of EPB 20, the brake piston 160 is electrically actuated by a motor 200. Motor 200 is linked to a drive screw 210 through a gear drive 220. Motor 200 and/or gear drive 220 are electrically linked to the BCM 110 through connector 230. BCM 110 controls current distribution to the motor 200. Where EPB 20 is not actuated after receiving an actuation command from the PCM 80, a warning signal is sent to a vehicle control module (or VCM) (not shown) over the vehicle CAN network. VCM can communicate a service request to the driver.

In this embodiment, EPB 20 is incorporated on the rear wheels. Alternatively, all four wheels can include the EPB or any combination of the wheels can be fitted with EPBs.

Now with reference to FIG. 2, there is shown therein another exemplary supplemental electric park brake system 300. An EPB 310 also locks the vehicle wheels to supplement transmission braking in this embodiment. As illustrated, the system 300 includes a transmission shifter 320. A keypad 330 is incorporated in the vehicle cabin so that a vehicle operator can command transmission gearing through the pad. Keypad 330 can include push buttons, soft keys or a rotating knob, for example. Shift commands from the vehicle operator are electronically sent to a PCM 340. In this embodiment, the available shift options are drive, 1^{st}, neutral, 2^{nd}, reverse and park.

In the embodiment of FIG. 2, PCM 340 determines transmission mode of operation. Where data related to shift command, as received from the keypad 320, does not match data related to transmission gear of operation, as detected by the PCM 340, PCM sends this information to a BCM 350. BCM 350 then sends an actuation command to the EPB 310. Particularly, when the shifter receives the park command and the PCM 340 does not detect that the transmission is in park the PCM 340 sends an actuation command.

In this embodiment, PCM 340 is linked to an actuator 360 for a transmission park pawl 370. Actuator 360 is motor powered, configured to pivot park pawl 370 with respect to teeth in the transmission housing 380. When the transmission is operating in park, pawl 370 pivots into engagement with a toothed surface 390 on the transmission housing 380 to lock the pawl with respect to the transmission housing. PCM 340 monitors power demand from the actuator motor. When the actuator motor demands power in excess of a predetermined limit (e.g., 20 watts) such power demand correlates to a park pawl engagement error. One park pawl error is, for example, park pawl tooth colliding with transmission housing teeth.

Exemplary conditions for BCM 350 transmittal of an actuation signal to the EPB 310 using the system illustrated in FIG. 2 is shown in Table 2.

TABLE 2
EPB Actuation to Supplement Transmission Braking

| Condition | Action |
|---|---|
| Shift command ≠ PCM detected | PCM sends actuation |
| mode of transmission operation | command to EPB |
| Pawl position ≠ Shift command | PCM sends actuation |
| | command to EPB |
| PCM receives current spike | PCM sends actuation |
| from pawl actuator | command to EPB |
| EPB not actuated | Warning signal to VCM |

Several conditions trigger BCM 350 to signal for EPB actuation. For example, where PCM 340 detects an abnormal current request from the park pawl actuator motor, PCM then sends this information to the BCM 350. BCM 350 then sends an actuation signal to the EPB 310. Likewise, where the park pawl position data does not match shift command data, PCM 340 sends an actuation signal to the BCM 350 to actuate the EPB 310.

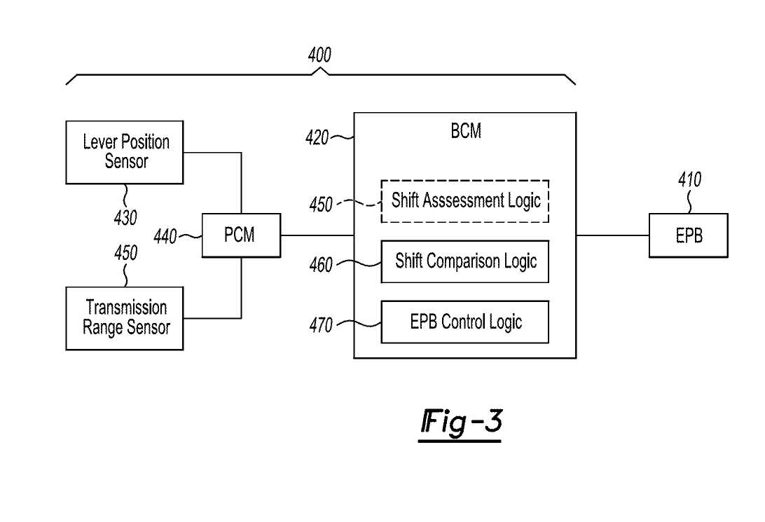

Now with reference to FIG. 3, there is shown therein a control circuit 400 for controlling an electric park brake 410. As shown in FIG. 3, the brake control module (or BCM) 420 is programmed to make assessments about transmission operation, particularly with respect to park instructions and actuate the EPB 410 to supplement transmission braking when needed. The control circuit 400 includes a lever position sensor 430 to detect user shift commands that are mechanically communicated to the transmission (e.g., through a shift lever, e.g., 40 as discussed with respect to FIG. 1). Lever position sensor 430, as shown in FIG. 3, is linked to the PCM 440. A transmission range sensor 450 is configured to detect transmission mode of operation and is also linked to the PCM 440.

BCM 420 is linked to the PCM 440. In this embodiment, PCM 440 continuously transmits data related to lever position and transmission range to the BCM 420. BCM 420 includes shift assessment logic 450 configured to receive data related to lever position and transmission range from the PCM 440. Shift assessment logic 450 can also be located in the PCM 440. BCM 420 also includes a program shift comparison logic 460 that compares shift-command data to transmission-operating-gear data to check whether the transmission mode of operation correlates to any shift commands received.

BCM 420 further includes EPB control logic 470 configured (or programmed) to control actuation of the motor in the EPB 410. When comparisons between shift data result in predetermined non-matching criteria BCM 420 actuates the EPB 410. The control circuit can include more or less components. Additionally, any one of the logics shown programmed in the BCM 420 can be incorporated into other vehicle control modules (e.g., the PCM 440).

While the best modes for carrying out the invention have been described in detail, those familiar with the art to which this invention relates will recognize various alternative designs and embodiments for practicing the invention within the scope of the appended claims.

We claim:

1. A method for controlling an electric park brake, comprising:
receiving shift-command data related to operator shift commands;
receiving transmission-operating-gear data related to a transmission mode of operation;
comparing shift-command data and transmission-operating-gear data; and
actuating an electric park brake when shift-command data fails to match transmission-operating-gear data.

2. The method of claim 1, further comprising:
receiving park-pawl data related to park pawl position;
comparing park-pawl data to shift-command data and transmission-operating-gear data; and
actuating the electric park brake when park-pawl data does not match shift-command data or transmission-operating-gear data.

3. The method of claim 1, further comprising:
checking the electric park brake when the shift-command data fails to match transmission-operating-gear data to determine if the electric park brake engaged after actuation; and
sending a warning signal if the electric park brake fails to engage.

4. A control module for supplemental park brake control, comprising:
shift assessment logic configured to receive shift-command data and transmission-operating-gear data;
shift comparison logic configured to compare shift-command data to transmission-operating-gear data; and
EPB control logic configured to actuate an electric park brake when shift-command data fails to match transmission-operating-gear data.

5. The control module of claim 4, wherein the control module is configured to receive the shift-command data from a transmission shifter.

6. The control module of claim 5, wherein the control module is configured to receive the shift-command data from a shift lever position sensor.

7. The control module of claim 4, wherein the control module is configured to receive transmission-operating-gear data from a transmission range sensor.

8. The control module of claim 4, wherein the control module is further configured to receive park-pawl data related to park pawl position and actuate the EPB when park-pawl data does not match shift-command data or transmission-operating-gear data.

9. The control module of claim 8, wherein the control module is configured to monitor power demand for a park-pawl actuator and correlate park pawl failure modes based on actuator power demands.

10. The control module of claim 4, wherein the brake control module is linked to a powertrain control module configured to send shift-command data or transmission-operating-gear data and actuate the electric park brake when park-pawl data does not match either shift-command data or transmission-operating-gear data.
The control module of claim 4, wherein the control module is configured to check the electric park brake when the shift-command data fails to match transmission-operating-gear data to determine if the electric park brake engaged after actuation and send a warning signal if the electric park brake fails to engage.

11. A vehicle with supplemental park brake system, comprising:
a shift lever;
a shift position sensor configured to detect shift lever position and electrically send signals related to shift lever position to a PCU; and
a transmission range sensor configured to send signals related to transmission operating gear to the PCU;
wherein the PCU is configured to communicate with a BCM configured to actuate an electric park brake when shift position data does not match transmission gear data.

12. The system of claim 11, further comprising:
a park pawl actuator configured to actuate a park pawl and send signals related to park pawl position to the PCU;
wherein the BCM is also configured to actuate the electric park brake when park pawl position does not match shift position or transmission gear.

13. The system of claim 12, further comprising:
a shift cable between the shift lever and a transmission configured to change transmission gears according to shift lever position.

14. The system of claim 11, wherein the BCM is configured to control a servo-motor in the electric park brake, the servo motor configured to actuate a brake caliper.

15. The system of claim 11, wherein the BCM is configured to monitor the power demand of a park-pawl actuator and correlate park pawl failure modes based on actuator power demands.

16. A vehicle with supplemental park brake system, comprising:
a PCU; and
a transmission shifter configured to send shift-command data to a PCU;
wherein the PCU is configured to receive transmission-operating-gear data; and
wherein the PCU is configured to communicate with a BCM configured to actuate an electric park brake when shift-command data does not match transmission-operating-gear data.

17. The system of claim 16, wherein the transmission shifter is an electric keypad.

18. The system of claim 16, wherein the BCM is configured to check the electric park brake when the shift-command data fails to match transmission-operating-gear data to determine if the electric park brake engaged after actuation and send a warning signal if the electric park brake fails to engage.

19. The system of claim 16, further comprising:
a park pawl actuator configured to actuate a park pawl and send signals related to park pawl position to the PCU;
wherein the BCM is also configured to actuate the electric park brake when park-pawl position data does not match shift-command data or transmission-operating-gear data.

20. The system of claim 19, wherein the BCM is configured to monitor the power demand of a park-pawl actuator and correlate park pawl failure modes based on actuator power demands.
